(19) United States
(12) Patent Application Publication
(10) Pub. No.: US 2006/0104612 A1
(43) Pub. Date: May 18, 2006

(54) Scrolling subtitle detecting device and method

(76) Inventor: Wang Jiunn Shyang, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,090

(22) Filed: May 10, 2005

(30) Foreign Application Priority Data
Nov. 12, 2004 (TW) 093134686

(51) Int. Cl. H04N 5/91

(52) U.S. Cl. 386/94

(57) ABSTRACT

A scrolling subtitle detecting device and method, which the device includes a receiving unit receiving a subtitle size data, a first subtitle data and a second subtitle data; and a detecting module detecting the first subtitle data and the second subtitle data to obtain a difference according to the subtitle size data for judging a scrolling information of the second subtitle data. Accordingly, the scrolling subtitle detecting device and method may eliminate serration at the edge of the subtitle while the subtitle having scrolling and scaling effects simultaneously, but also excite the viewer's joy of the sight and improve the quality of the playing subtitle.

### BACKGROUND OF THE INVENTION

1. Field of Invention

The present invention relates to a scrolling subtitle detecting device and method, and in particular, to the detecting device and method which detects a first subtitle data and a second subtitle data for obtaining a scrolling information of the second subtitle data.

2. Related Art

The quality becomes an essential factor in purchasing since the technology progressing and the living standard goes higher. The most popular information technical product is the audio/video player of the multimedia player-related. Accordingly, the corresponding image effects turn into a focus on researches of audio/video playing.

The common image effect is the subtitle processing, especially the subtitle scrolling up/down and the subtitle scaling up/down. In the conventional subtitle scrolling, the subtitle decoder decodes the subtitle data stream of a disc and then generates the subtitle data with a plurality blocks and start address for a audio/video player to achieve the subtitle scrolling effect by adjusting the start address. In addition, the conventional subtitle scaling up/down replicating and appending to the blocks and extracting the blocks of the fixed position respectively.

However, while the subtitle having scrolling and scaling effects simultaneously, the serration occurs in the edge of the subtitle since the audio/video player accesses the start address drawn out in the scaling process, and the subtitle and image quality in conflict with the user's demand.

Accordingly, the avoidance of the audio/video player accessing the start address drawn out in the scaling process and the elimination of serration is the requirement of the subtitle effect. Hence, a scrolling subtitle detecting device and method is proposed as one solution of the subtitle serration and the scaling and scrolling effect co-operating problem.

### SUMMARY OF THE INVENTION

In view of the foregoing, the invention provides a scrolling subtitle detecting device, which includes a receiving unit for receiving a subtitle size data, a first subtitle data and a second subtitle data; and a detecting module for detecting the first subtitle data and the second subtitle data to obtain a difference according to the subtitle size data for judging a scrolling information of the second subtitle data.

In addition, the invention provides a scrolling subtitle detecting method including the steps of receiving a subtitle size data, a first subtitle data and a second one; and obtaining a difference from detecting the first subtitle data and the second one according to the subtitle size data for judging a scrolling information of the second subtitle data.

Moreover, the invention provides a scrolling subtitle detecting device and method having a receiving unit and a detecting module for obtaining a scrolling information including the scrolling up, scrolling down and scrolling quantity of the subtitle of the second subtitle data through detecting the first subtitle data and the second one for the eliminating the serration of the scrolling subtitle.

As mentioned above, the scrolling subtitle detecting device and method detecting blocks of the first subtitle data and the second one of the receiving unit; recording times of the second one equaling to the first one in a counter; comparing the counter with a threshold for judging whether the second one is a scrolling subtitle or not; comparing a start address of blocks of the first subtitle data with the one of the second subtitle data for obtaining the difference while the second subtitle data is the scrolling subtitle; and judging a scrolling information of the second subtitle data according to the difference for eliminating the serration of subtitle and improving the playing quality of the subtitle.

### BRIEF DESCRIPTION OF THE DRAWINGS

The invention will become more fully understood from the detailed description given herein below illustration only, and thus is not limitative of the present invention, and wherein:

FIG. 1 is a block diagram showing a scrolling subtitle detecting device according to a preferred embodiment of the invention.

FIG. 2 is a block diagram showing a scrolling subtitle detecting device according to another preferred embodiment of the invention.

FIG. 3 is a flow chart showing the steps of a scrolling subtitle detecting method according to another preferred embodiment of the invention.

FIG. 4 is a schematic view showing the detecting module of the invention.

FIG. 5 is a block diagram showing a scrolling subtitle detecting device applying to a digital medium player according to another preferred embodiment of the invention.

### DETAILED DESCRIPTION OF THE INVENTION

The present invention will be apparent from the following detailed description, which proceeds with reference to the accompanying drawings, wherein the same references relate to the same elements.

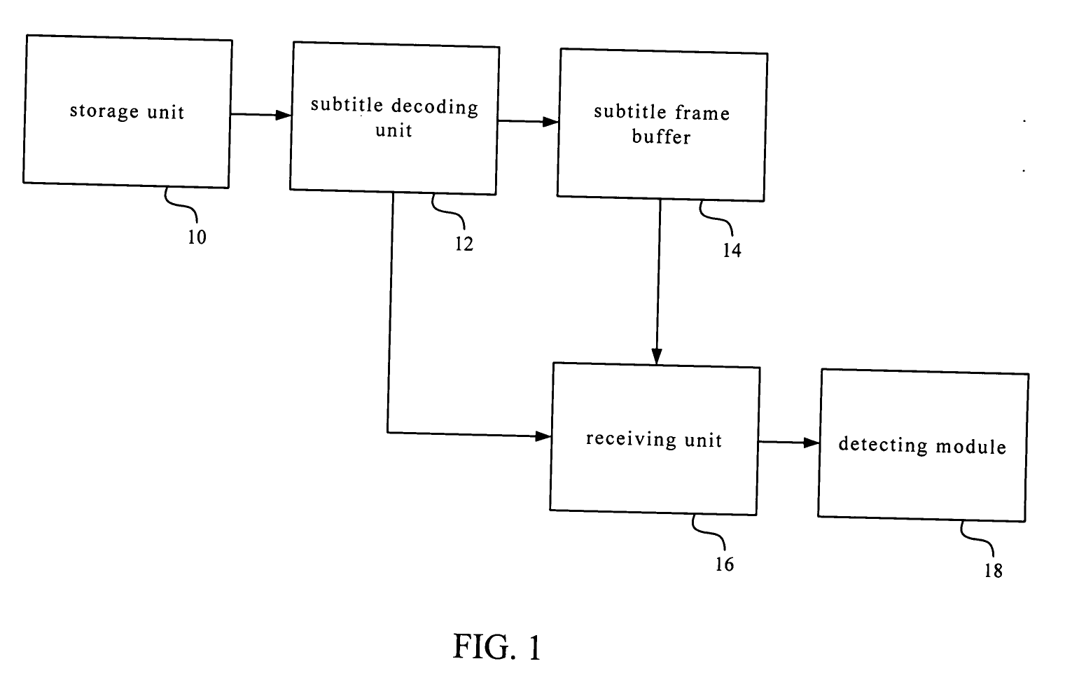

With reference to FIG. 1, a block diagram showing a scrolling subtitle detecting device according to a preferred embodiment of the invention includes a receiving unit 16 for receiving a subtitle size data, a first subtitle data and the second one, and a detecting module 18 for detecting the first subtitle data and the second one of the receiving unit 16 to obtain a difference according to the subtitle size data for judging a scrolling information of the second subtitle data.

Besides, the scrolling subtitle detecting device of the invention further includes a storage unit 10 which provides the subtitle data stream, and a subtitle decoding unit 12 which decodes the subtitle data stream to generate the subtitle size data, the first subtitle data and the second one to the receiving unit 16 and a subtitle frame buffer 14 respectively, and then the first subtitle data and the second one stored in the subtitle frame buffer 14 are forwarded to the receiving unit 16 for detecting by the detecting module 18.

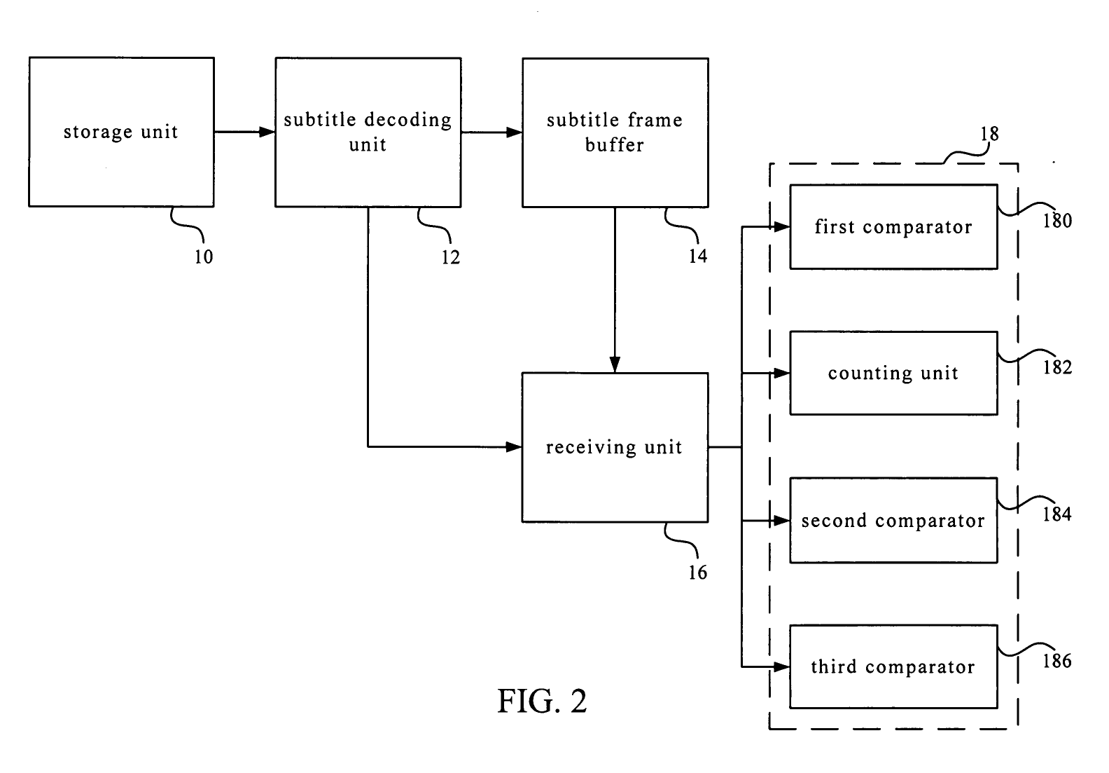

With reference to FIG. 2, a scrolling subtitle detecting device according to another preferred embodiment of the invention includes the detecting module 18 having a first comparator 180, which compares blocks of the first subtitle data classified according to the subtitle size data with a subtitle a length parameter and a width parameter with blocks of the second one; a counting unit 182, which includes a counter and records times of the blocks of the second one equaling to the first one; a second comparator 184, which compares the counter with a threshold for judging whether the second subtitle data is a scrolling subtitle or not; and a third comparator 186, which compares a start address of blocks of the first subtitle data with the one of the second subtitle data for obtaining the difference while the second subtitle data is the scrolling subtitle. It's noted that the start address is the location of blocks of the subtitle data. Moreover, the detecting module 18 judges a scrolling information including the scrolling up, scrolling down, and start address offset of scrolling subtitle according to the difference.

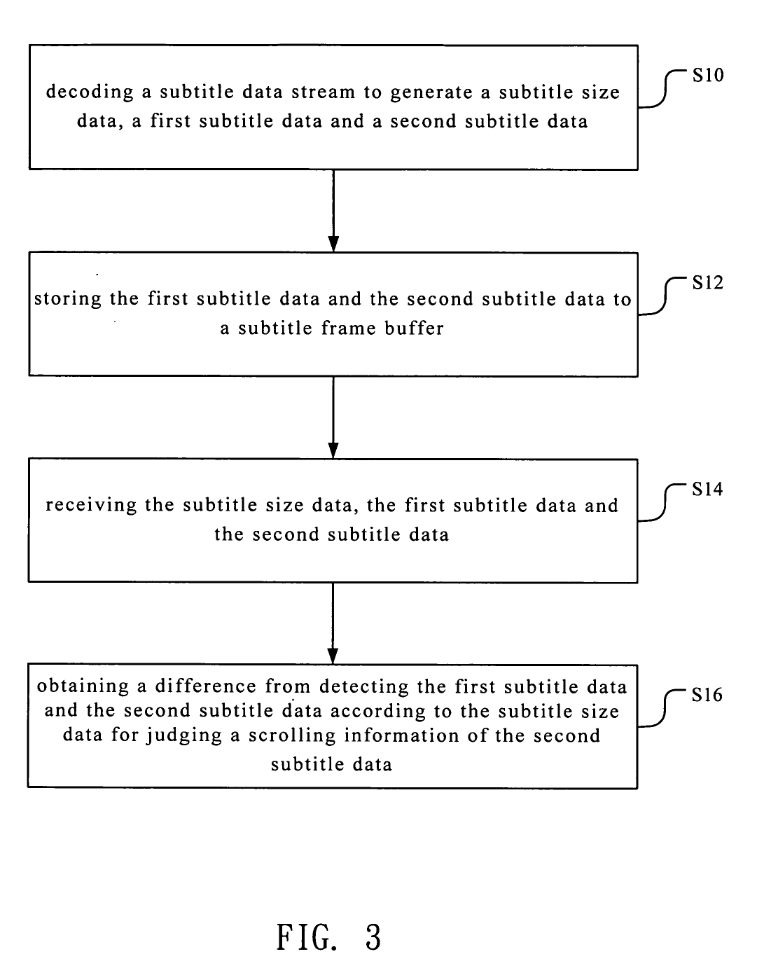

With reference to FIG. 3, a flow chart showing the steps of a scrolling subtitle detecting method according to another preferred embodiment of the invention includes of receiving a subtitle size data, a first subtitle data and the second one in the step S14, and obtaining a difference from detecting the first subtitle data and the second one according to the subtitle size data for judging a scrolling information of the second subtitle data in the step S16.

Moreover, the scrolling subtitle detecting method of the invention further includes of decoding a subtitle data stream to generate the subtitle size data, the first subtitle data and the second one in the step S10, and then storing the first one and the second one to a subtitle frame buffer in the step S12 before performing the step S14.

Furthermore, the step S16 further includes the steps of comparing blocks of the first subtitle data with the second one; providing a counter and accumulating the counter while the blocks of the second one equaling to the first one; comparing the counter with a threshold, and judging the second subtitle data is scrolling while the counter equaling to the threshold; comparing a start address of blocks of the first subtitle data with the one of the second subtitle data for obtaining the difference while the second one is scrolling; and judging a scrolling information of the second subtitle data according to the difference.

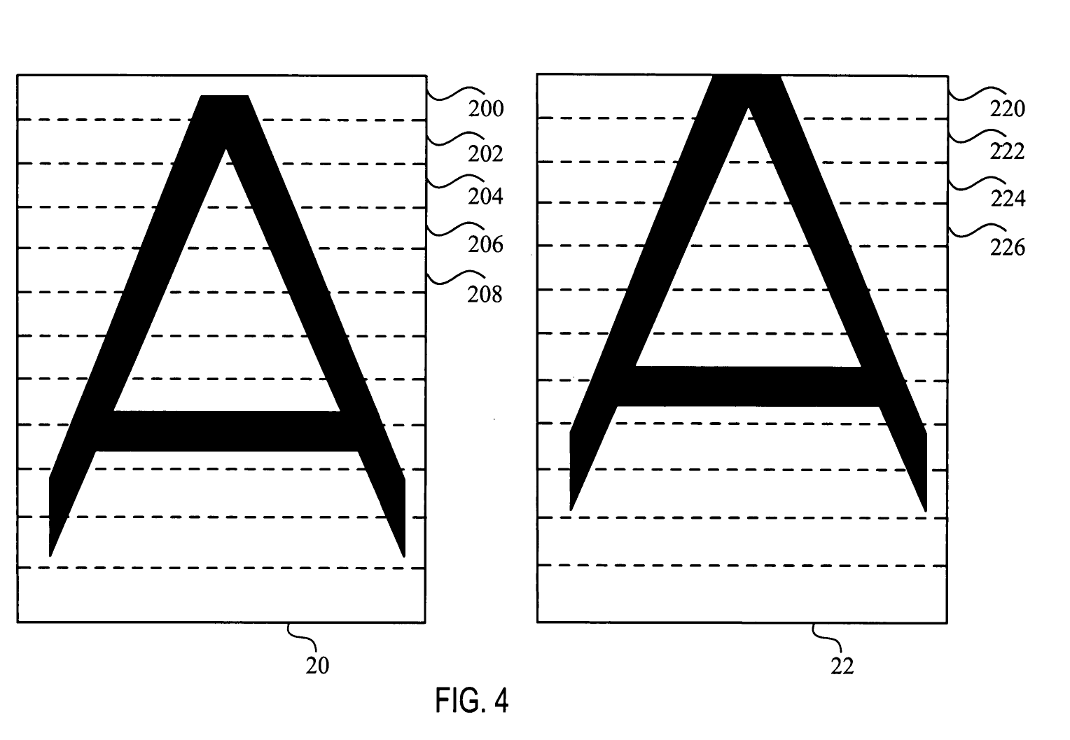

With reference to FIG. 4, the detecting module 18 includes a first subtitle data 20 and a second subtitle data 22, where the length and width of the first subtitle data 20 and the second subtitle data 22 is determined according to a subtitle length parameter and a subtitle width of the subtitle size data. In the embodiment, the first subtitle data 20 includes a first block 200, a second block 202, a third block 204, a fourth block 206 and a fifth block 208, whereas the second subtitle data 22 includes a first block 220, a second block 222, a third block 224 and a fourth block 226.

Moreover, since a threshold is equal to four and the counter zero initially in the embodiment, the first comparator 180 of the detecting module 18 compares the first block 200 of the first subtitle data 20 with the first block 220 of the second subtitle data 22, and then compares the first block 200 with the second block 222, third block 224 and the fourth block 226 since the first block 200 is not equal to the first block 220 third block 224 and the fourth block 226. Because of the inequality, the detecting module 18 compares the second block 202 of the first subtitle data 20 with the first block 220 of the second subtitle data 22. Because of the equality, the counting unit 182 of the detecting module 18 accumulates the counter and the second comparator 184 of the detecting module 18 compares the counter with a threshold, and the comparison result can't be taken as a judging basis since the counter is less than the threshold at present. The detecting module 18 compares the third block 204 of the first subtitle data 20 with the first block 222 of the second subtitle data 22, and the rest may be deduced by analogy to conclude that the second subtitle data is a scrolling subtitle. In other words, the counter is equal to the threshold when the third block 204, the fourth block 206 and the fifth block 208 of the first subtitle data 20 are equal to the second block 222, the third block 224 and the fourth block 226 of the second subtitle data 22 respectively, and the second subtitle data may be viewed as a scrolling subtitle. Consequently, the third comparator 186 of the detecting module 18 compares a start address of the blocks of the first subtitle data with the one of the second subtitle data for obtaining the difference while the second subtitle data is the scrolling subtitle. The difference is −1 since the start address of the second block 202 is 2 and the one of the first block 220 is 1, the second subtitle data is scrolling up and the start address offset of scrolling subtitle is 1. By contrast, the second subtitle data is scrolling down while the difference is a positive number.

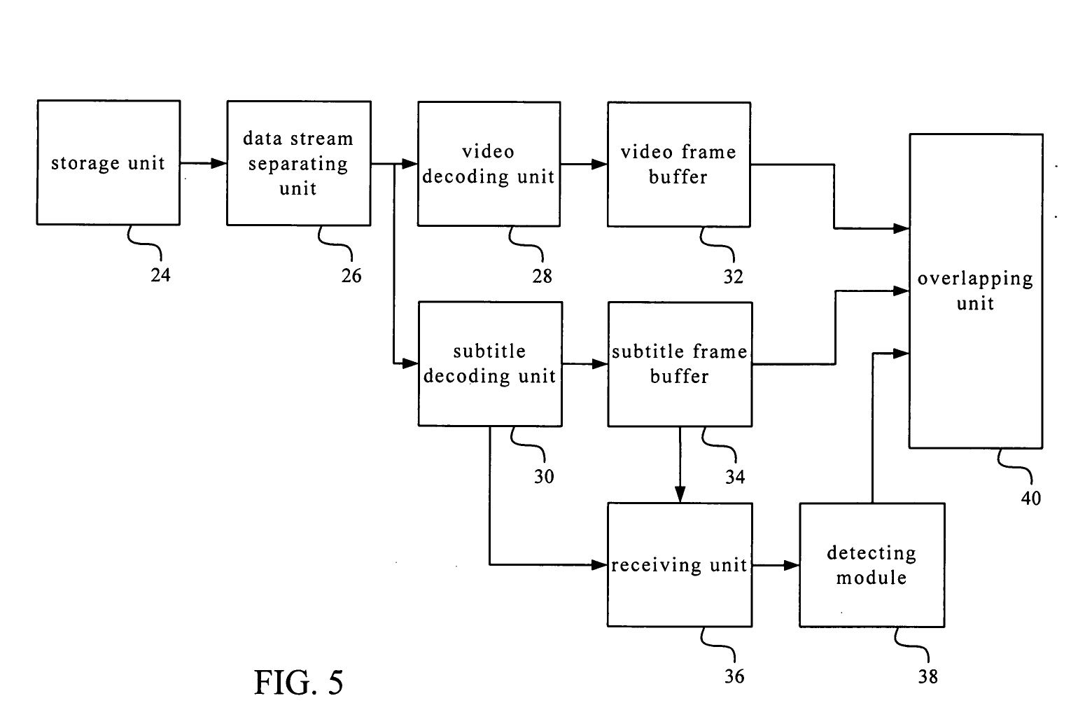

With reference to FIG. 5, a scrolling subtitle detecting device applying to a digital medium player according to another preferred embodiment of the invention includes a storage unit 24, which provides an audio and video data stream comprising the subtitle data stream; a data stream separating unit 26, which separates the subtitle data stream from the audio and video data stream; a subtitle decoding unit 30, which decodes the subtitle data stream to generate a subtitle size data, a first subtitle data and a second one; a subtitle frame buffer 34, which stores the first subtitle data and the second one of the subtitle decoding unit 30; a receiving unit 36, which receives the subtitle size data of the subtitle decoding unit 30 and the first subtitle data and the second one of the subtitle frame buffer 34; and a detecting module 38, which detects the first subtitle data and the second one and obtaining a difference for judging a scrolling information of the second one.

Moreover, the scrolling subtitle detecting device applying to a digital medium player according to another preferred embodiment of the invention further includes an overlapping unit 40, which overlaps a first video signal, the first subtitle data, a second video signal, the second subtitle data and the scrolling information stored in the detecting module 38 to a display wherein a video decoding unit 28 decodes the video stream to produce the first video signal and the second one and stores them in a video frame buffer 32.

Furthermore, the detecting module 38 further includes a first comparator, a counting unit, a second comparator, and a third comparator for performing the functions as described above.

In addition, the scrolling subtitle detecting device and method of the invention can be embodied through firmware and hardware.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A scrolling subtitle detecting device, comprising:
a receiving unit, which receives a subtitle size data, a first subtitle data and a second subtitle data; and
a detecting module, which detects the first subtitle data and the second subtitle data to obtain a difference according to the subtitle size data for judging a scrolling information of the second subtitle data.

2. The device of claim 1, wherein the subtitle size data further comprising a subtitle length parameter and a subtitle width parameter.

3. The device of claim 1, further comprising:
a subtitle decoding unit, which decodes a subtitle data stream to generate the subtitle size data, the first subtitle data and the second subtitle data.

4. The device of claim 3, further comprising:
a subtitle frame buffer, which stores and outputting the first subtitle data and the second subtitle data of the subtitle decoding unit.

5. The device of claim 1, wherein the detecting module further comprising:
a first comparator, which compares a plurality blocks of the first subtitle data with a plurality blocks of the second subtitle data according to the subtitle size data;
a counting unit, which comprises a counter and records times of the plurality blocks of the second subtitle data equaling to the plurality blocks of the first subtitle data;
a second comparator, which compares the counter with a threshold for judging whether the second subtitle data is a scrolling subtitle or not; and
a third comparator, which compares a start address of the plurality blocks of the first subtitle data with a start address of the plurality blocks of the second subtitle data for obtaining the difference while the second subtitle data is the scrolling subtitle.

6. The device of claim 5, wherein the start address is the locations of blocks of the first subtitle data and the plurality blocks of the second subtitle data.

7. The device of claim 5, wherein the threshold is four at least.

8. The device of claim 1, wherein the scrolling information is scrolling up.

9. The device of claim 1, wherein the scrolling information is scrolling down.

10. The device of claim 1, wherein the scrolling information is a start address offset of scrolling subtitle.

11. A scrolling subtitle detecting method, comprising:
receiving a subtitle size data, a first subtitle data and a second subtitle data; and
obtaining a difference from detecting the first subtitle data and the second subtitle data according to the subtitle size data for judging a scrolling information of the second subtitle data.

12. The method of claim 11, further comprising:
decoding a subtitle data stream to generate the subtitle size data, the first subtitle data and the second subtitle data.

13. The method of claim 12, further comprising:
storing the first subtitle data and the second subtitle data to a subtitle frame buffer.

14. The method of claim 11, further comprising:
comparing a plurality blocks of the first subtitle data with a plurality blocks of the second subtitle data;
providing a counter and accumulating the counter while the plurality blocks of the second subtitle data equaling to the plurality blocks of the first subtitle data;
comparing the counter with a threshold, and judging the second subtitle data is scrolling while the counter equaling to the threshold; and
comparing a start address of the plurality blocks of the first subtitle data with a start address of the plurality blocks of the second subtitle data for obtaining the difference while the second subtitle data is scrolling.

15. A scrolling subtitle detecting device applying to a digital medium player, comprising:
a subtitle decoding unit, which decodes a subtitle data stream to generate a subtitle size data, a first subtitle data and a second subtitle data;
a subtitle frame buffer, which stores the first subtitle data and the second subtitle data of the subtitle decoding unit;
a receiving unit, which receives the subtitle size data of the subtitle decoding unit and the first subtitle data and the second subtitle data of the subtitle frame buffer; and
a detecting module, which detects the first subtitle data and the second subtitle data and obtaining a difference for judging a scrolling information of the second subtitle data.

16. The device of claim 15, further comprising:
a storage unit, which provides an audio and video data stream comprising the subtitle data stream.

17. The device of claim 15, further comprising:
an overlapping unit, which overlaps a first video signal, the first subtitle data, a second video signal, the second subtitle data and the scrolling information to a display.

18. The device of claim 15, wherein the detecting module further comprising:
a first comparator, which compares a plurality blocks of the first subtitle data with a plurality blocks of the second subtitle data according to the subtitle size data;
a counting unit, which comprises a counter and records times of the plurality blocks of the second subtitle data equaling to the plurality blocks of the first subtitle data;
a second comparator, which compares the counter with a threshold for judging whether the second subtitle data is a scrolling subtitle or not; and
a third comparator, which compares a start address of the plurality blocks of the first subtitle data with a start address of the plurality blocks of the second subtitle data for obtaining the difference while the second subtitle data is the scrolling subtitle.

19. The device of claim 18, wherein the start address is the location of blocks of the first subtitle data and the location of the plurality blocks of the second subtitle data respectively.

20. The device of claim 15, wherein the scrolling information is selected from one of the group of scrolling up, scrolling down, and a start address offset of scrolling subtitle.
